(19) United States
(12) Patent Application Publication
(10) Pub. No.: US 2001/0030021 A1
(43) Pub. Date: Oct. 18, 2001

(54) Methods for preventing contamination of products from product labels and adhesives

(76) Inventors: Paul W. Romig, Novato, CA (US); Robert J. Kellar, Napa, CA (US)

Correspondence Address: Marc A. Sockol, Squire, Sanders & Dempsey L.L.P., 600 Hansen Way, Palo Alto, CA, 94304-1043, US

(21) Appl. No.: 09/810,794

(22) Filed: Mar. 15, 2001

Related U.S. Application Data
(62) Division of application No. 09/513,239, filed on Feb. 24, 2000.

(51) Int. Cl. B32B 31/20

(52) U.S. Cl. 156/308.2

(57) ABSTRACT

A method places a metallic layer between printing and a semi-permeable container to protect the contents of the container from printed layer inks and adhesives. The method comprises obtaining a semi-permeable container having a polymeric external surface, obtaining a metallic layer, placing the metallic layer against the external surface, and melting at least a portion of the external surface beneath the metallic layer. The metallic layer may include metallized polyester. A safe container comprises a semi-permeable container having a polymeric external surface, and a metallic layer bonded directly to the external surface

### BACKGROUND OF THE INVENTION

1. Field of the Invention

This invention relates generally to containers, and more particularly provides methods and containers for preventing contamination of food products, medical products, pharmaceutical products, biological products and other products that are preferably kept pure from product labels and adhesives.

2. Description of the Background Art

Food products, medical products, pharmaceutical products and biological products are typically packaged, transported and sold in semi-permeable containers, such as plastic (e.g., polyethylene, polypropylene or other polymer) bottles or cellophane-wrapped Styrofoam plates. Examples of such products include prepackaged meats, prepackaged dairy, prepackaged fish, blood, IV fluids, ear drops, eye drops, and pills. Other examples of such products include biological reagents such as restrictive enzymes, antibodies, etc., and liquid biological, infusible and injectible products such as dermal patches, etc. Examples of such containers include food containers, blood bags, IV bags, ear drop containers, eye drop containers, pill containers, etc.

To identify the product contents within the semi-permeable containers, manufacturers, supermarkets, pharmacists, doctors, scientists or other packagers place labels onto the semi-permeable containers typically using adhesives.

Unfortunately, label inks and adhesives and other label materials migrate through the semi-permeable container and contaminate the product contents. This problem is especially prevalent in the pharmaceutical industry, where the pharmaceutical products are stored for longer periods of time. Therefore, methods and containers for preventing contamination of products packaged in semi-permeable containers from product labels and adhesives are needed.

### SUMMARY OF THE INVENTION

The present invention provides methods for placing a metallic layer between printing and a semi-permeable container to protect the product contents from printed layer adhesives or inks, and thus also provides safe containers. Accordingly, the printing can be placed directly onto the metallic layer or onto a separate layer which is placed over the metallic layer.

In one embodiment, the method comprises obtaining a semi-permeable container having a polymeric external surface, obtaining a metallic layer, placing the metallic layer against the external surface, and melting at least a portion of the external surface beneath the metallic layer. The metallic layer may include metallized polyester such as Mylar® metallized polyester manufactured by E.I duPont de Nemours and Company

In another embodiment, the method comprises obtaining a semi-permeable container having an external surface, obtaining a metallic layer, placing polymeric material between the external surface and the metallic layer, and melting at least a portion of the polymeric material.

In yet another embodiment, the method comprises obtaining a semi-permeable container having an external surface and having a metallic layer bonded to the external surface, and coupling a printed layer to the metallic layer.

The method of the present invention advantageously places a protective metallic layer onto semi-permeable container to prevent label inks and adhesives from migrating into the container. Thus, the protective layer helps to prevent contamination of the product contents.

### BRIEF DESCRIPTION OF THE DRAWINGS

FIG. 1 is a block diagram illustrating a first system for bonding a printed metallic label to a semi-permeable container, in accordance with the present invention;

FIG. 2 is a cross-sectional view of the safe container having the printed metallic label bonded thereon, in accordance with the first system;

FIG. 3 is a block diagram illustrating a second system for bonding a printed metallic label to a semi-permeable container, in accordance with the present invention;

FIG. 4 is a block diagram illustrating a third system for bonding a printed metallic label to a semi-permeable container, in accordance with the present invention; and

FIG. 5 is a cross-sectional view of the safe container having the printed metallic label bonded thereon, in accordance with the second or third system.

### DETAILED DESCRIPTION OF THE PREFERRED EMBODIMENT

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

FIG. 1 is a block diagram illustrating a first system 100 for bonding a printed metallic label 120 to a semi-permeable polymeric container 105, such as to a blood bag, IV bag, a food package, a pharmaceutical bottle, an eye drop bottle, etc., in accordance with an embodiment of the present invention. System 100 includes a bonding machine 110 for receiving the printed metallic label 120 and the semi-permeable polymeric container 105, and for bonding the printed metallic label 120 to the semi-permeable polymeric container 105 to create a “safe” container 115. Because of the techniques taught herein, the safe container 115 is safe for packaging products intended to be kept pure. As stated above, such products may be pharmaceutical, medical, biological, ingestible or the like. Examples of such products may include prepackaged meats, prepackaged dairy, prepackaged fish, blood, IV fluids, ear drops, eye drops, and pills. Other examples of such products may include biological reagents such as restrictive enzymes, antibodies, etc., and liquid biological, infusible and injectible products such as dermal patches, etc. Still other examples of such products may include any product intended to be ingested by, injected into, removed from, applied to, or come into contact with humans or animals.

The printed metallic label 120 preferably includes a metallic layer, i.e., a metal (e.g., aluminum, tin, gold, silver, copper, etc.) foil or metalized material such as metallized polyester (e.g., Mylar(metallized polyester manufactured by E. I. duPont de Nemours and Company). The printed metallic label 120 includes printing on one side (i.e., the printed side) and no printing on the other side (i.e., the unprinted side). As stated above in the Description of the Background Art, the typical semi-permeable polymeric container 105 is typically formed from a polymeric material such as polyethylene or polypropylene.

The bonding machine 110 places the unprinted side of the printed metallic label 120 onto the typical semi-permeable polymeric container 105, and inductively, directly, radiantly, convectively, conductively, frictionally, or otherwise heats the label 120 and thus the external surface of the polymeric container 105 to a temperature between, for example, 80 and 150 degrees Fahrenheit. The temperature selected melts the polymeric material of the external surface of the container 105. preferably without deforming the shape of the polymeric container 105. By melting at least a portion of the external surface of the container 105 beneath the printed metallic label 120, the label 120 fuses to the container 105, thereby creating the safe container 115.

Any conventional bonding machines 110 can be used. The bonding machine 110 may include a labeler head (not shown) for receiving uncut printed metallic label material, a cutter (not shown) for cutting the uncut printed metallic label material to form the label 120, a vacuum cylinder (not shown) for holding the printed metallic label 120, levers (not shown) for moving the printed metallic label 120 and for placing the label 120 against the container 105, and heating elements (not shown) for heating the label 120 and/or container 105 to fuse them together. Alternatively, the bonding machine 110 may use cut labels (not shown).

It will be appreciated that the bonding machine 110 may heat the label 120 to temperatures outside the example range, so long as the material of the polymeric container 105 and printed metallic label 120 fuse. It will be further appreciated that the printing on the printed side of the printed metallic label 120 preferably withstands heat. It will be further appreciated that other methods of heating the external surface of the container 105 beneath the printed metallic label 120, such a ovens, heating elements, etc., can alternatively or additionally be used. It will be appreciated that only a portion of the external surface beneath the label need be formed of polymeric material. It will be still further be appreciated that, after heating, the safe container 115 can be allowed to cool normally, can be moved to a cold chamber, or can be dipped into cold liquid. Still further, the printing on the metallic label 120 can be placed onto the metallic label 120 after being fused to the container 105.

In an alternative embodiment, the bonding machine 110 can place a polymeric bonding agent, such as polyethylene or polypropylene, between the container 105 and the printed metallic layer 120 before heating to facilitate the bonding process. The polymeric bonding agent may have a melting temperature lower than that of the semi-permeable polymeric container 105, so that, during the heating process, the container 105 is not deformed, burned or in any way compromised. In this alternative embodiment, the polymeric bonding agent will adhere to the container 105, and the printed metallic layer 120 will adhere to the polymeric bonding agent.

It will be appreciated that the techniques described above do not use adhesives, and provide a barrier between the printed layer and the semi-permeable polymeric container 105, thereby protecting the contents from label contaminants.

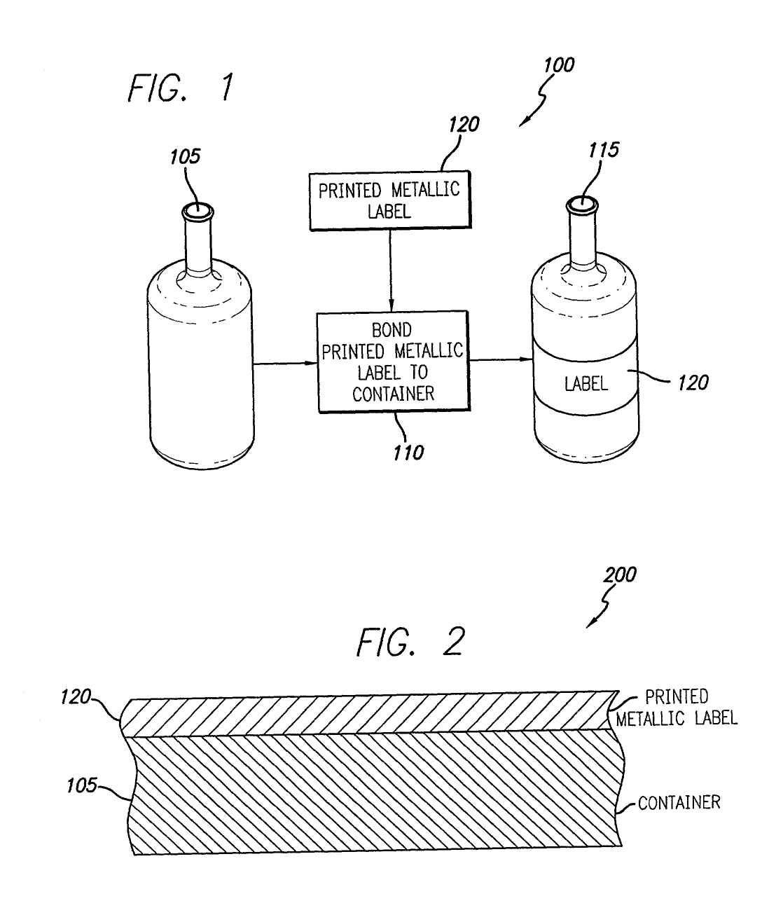

FIG. 2 illustrates a cross-sectional view 200 of the safe container 115 having the printed metallic label 120 attached to the semi-permeable container 105, in accordance with the first system 100. Although not shown, one skilled in the art will recognize that a polymeric bonding agent may be disposed between the printed metallic label 120 and the semi-permeable polymeric container 105, as described above.

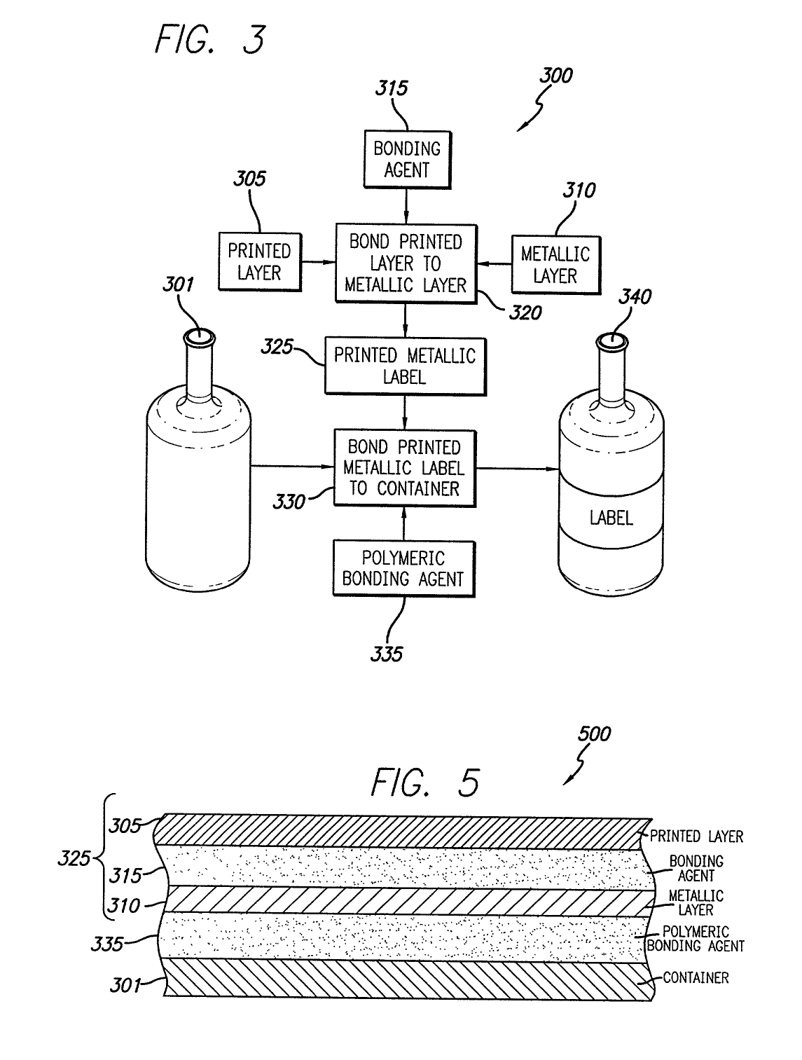

FIG. 3 is a block diagram illustrating a second system 300 for bonding a printed metallic label 325 to the semi-permeable container 301, in accordance with the present invention. The system 300 includes a printed metallic label generating machine 320 coupled to a bonding machine 330 (which is similar to the bonding machine 110 of FIG. 1).

The printed metallic label generating machine 320 receives a printed layer 305, a metallic layer 310 and a bonding agent 315, and bonds them together to form the printed metallic label 325. In one embodiment, the printed metallic label generating machine 320 applies polymeric material as the bonding agent 315 between the printed layer 305 and the metallic layer 310, and melts the polymeric material to fuse the printed layer 305 to the metallic layer 310. In another embodiment, the printed metallic label generating machine 320 applies an adhesive such as conventional glue or laminate as the bonding agent. Accordingly, after the printed metallic label 325 is fused to the semi-permeable container 301, the metallic layer 310 will prevent the adhesive from contacting the semi-permeable container 301. In yet another embodiment, the printed layer 305 can be just ink, paint, graphite, or other printing material, and can be placed directly onto the metallic layer 310. In still another embodiment, the printed metallic label generating machine 320 can be a human holding an ink pen or other writing utensil.

The bonding machine 330 receives the printed metallic label 325, the semi-permeable container 301 and, possibly, polymeric bonding agent 335, and bonds them together to form the safe container 340. The bonding machine 330 places the polymeric bonding agent 335, i.e., polymeric material, between the metallic layer 310 of the printed metallic label 325 and the external surface of the semi-permeable container 301, and melts the polymeric bonding agent 335. The metallic layer 310 and the semi-permeable container 301 fuse together, thereby creating the safe container 340. Alternatively, no polymeric bonding agent 335 need be used. That is, the bonding machine 330 can melt the external surface of the container 301 to bond the printed metallic label 325 thereto.

One skilled in the art will recognize that, if the bonding agent 315 includes polymeric material, its melting temperature may be selected to be higher than that of the polymeric bonding agent 335. Thus, the bonding machine 330 can melt the polymeric bonding agent 335 between the container 301 and the label 325 without melting the polymeric bonding agent 315 within the label 325. A cross-sectional view of the resulting safe container 340 is illustrated and described with reference to FIG. 5.

Although not shown, one skilled in the art will recognize that many other alternatives are possible. For example, the bonding machine 330 can sandwich the semi-permeable container 301 to the bonding agent 315 to the metallic layer 310 to the polymeric bonding agent 335 to the printed layer 305, and can heat them in a single step. Accordingly, only a single machine would be needed. Also, if the heat is transferred from the outside layer inward, the first polymeric bonding agent 315 may be selected to have a lower melting temperature than that of the second polymeric bonding agent 335, since an outside layer would get hotter than an inside layer. One skilled in the art will recognize that the same polymeric bonding agent 315/335 could alternatively be used.

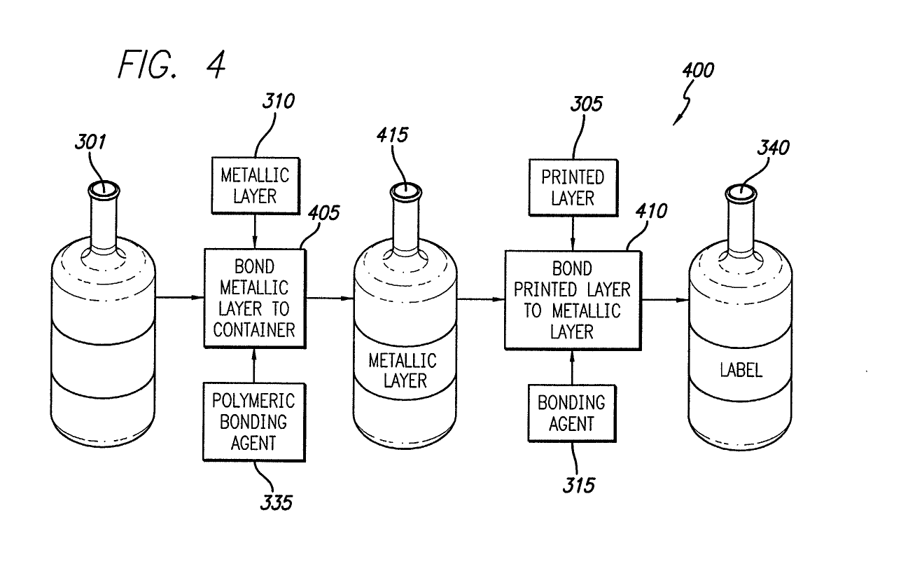

FIG. 4 is a block diagram illustrating a third system 400 for bonding a metallic layer 310 and a printed layer 305 to a semi-permeable container 301, in accordance with the present invention. The system 400 includes a metallic layer bonding machine 405 and a printed layer bonding machine 410.

The metallic layer bonding machine 405 receives the metallic layer 310, the semi-permeable container 301 and polymeric bonding agent 335, places the polymeric bonding agent 335 between the metallic layer 310 and the semi-permeable container 301, and melts the polymeric bonding agent 335. Fusing the metallic layer 310 to the semi-permeable container 301 creates a safe “generic” container 415, which can be shipped to end-packagers, e.g., pharmacists, supermarkets, etc. It will be appreciated that the metallic layer bonding machine 405 and the printed layer bonding machine 410 need not be at the same location.

The printed layer bonding machine 410 receives the safe generic container 415, the printed layer 305 and the bonding agent 315, and bonds the printed layer 305 to the metallic layer 310, thereby generating the safe container 115. As with reference to FIG. 3, the bonding agent 315 may be adhesive or polymeric material. If the bonding agent 315 is polymeric material, then the printed layer bonding machine 410 melts the bonding agent 315. It will be appreciated that the polymeric bonding agent 315 may be selected to have a melting temperature lower than the polymeric bonding agent 335. If the bonding agent is adhesive, then the metallic layer 310 already bonded to the semi-permeable container 105 will act as a barrier to prevent contamination of its contents.

It will be appreciated that, in this system 400, the application of the printed layer can be performed by a human (i.e., the printed layer bonding machine 410 can be a human). It will be further appreciated that the printed layer can be just ink, paint, graphite, or other printing material, and can be placed directly onto the metallic layer 310 of the safe generic container 415. No bonding agent 315 would be needed. It will still be further appreciated that the adhesive may be predisposed on the printed layer 305.

FIG. 5 is a cross-sectional view 500 of the safe container 115 having the printed metallic label 325 attached to the semi-permeable container 105, in accordance with the second system 300 or third system 400. More particularly, the cross-sectional view 500 illustrates the printed layer 305 fused to a bonding agent 315, e.g., adhesive or polymeric material, in turn fused to the metallic layer 310. As illustrated the printed layer 305, bonding agent 315 and metallic layer 310 form the printed metallic label 325. The cross-sectional view 500 further illustrates the metallic layer 310 fused to a polymeric bonding agent 335 in turn fused to the semi-permeable container 105.

The foregoing description of the preferred embodiments of the present invention is by way of example only, and other variations and modifications of the above-described embodiments and methods are possible in light of the foregoing teaching. The embodiments described herein are not intended to be exhaustive or limiting. The present invention is limited only by the following claims:

What is claimed is:

1. A method, comprising:
obtaining a semi-permeable container having a polymeric external surface;
obtaining a metallic layer;
placing the metallic layer against the external surface; and
melting at least a portion of the external surface beneath the metallic layer.

2. The method of claim 1, wherein the semi-permeable container includes a plastic bottle.

3. The method of claim 1, wherein the semi-permeable container includes a plastic pharmaceutical bottle.

4. The method of claim 1, wherein the semi-permeable container includes an IV bag.

5. The method of claim 1, wherein the semi-permeable container includes a plastic-wrapped food package.

6. The method of claim 1, further comprising coupling a printed layer onto the metallic layer.

7. The method of claim 1, wherein the metallic layer includes metallized polyester.

8. A safe container, comprising:
a semi-permeable container having a polymeric external surface; and
a metallic layer bonded directly to the external surface.

9. The safe container of claim 8, further comprising a printed layer coupled onto the metallic layer.

10. The safe container of claim 8, wherein the metallic layer includes metallized polyester.

11. A method, comprising:
obtaining a semi-permeable container having an external surface;
obtaining a metallic layer;
placing polymeric material between the external surface and the metallic layer; and
melting at least a portion of the polymeric material.

12. The method of claim 11, wherein the semi-permeable container includes a plastic bottle.

13. The method of claim 11, wherein the semi-permeable container includes a pharmaceutical bottle.

14. The method of claim 11, wherein the semi-permeable container includes an IV bag.

15. The method of claim 11, wherein the semi-permeable container includes a food package.

16. The method of claim 11, further comprising coupling a printed layer onto the metallic layer.

17. The method of claim 11, wherein the melting temperature of the polymeric material is less than the melting temperature of the semi-permeable container.

18. The method of claim 11, wherein the metallic layer includes metallized polyester.

19. A safe container, comprising:
a semi-permeable container having an external surface;
polymeric material bonded to the external surface; and
a metallic layer bonded to the polymeric material.

20. The safe container of claim 19, further comprising a printed layer coupled to the metallic layer.

21. The safe container of claim 19, wherein the metallic layer includes polyester.

22. A method, comprising:
obtaining a semi-permeable container having an external surface and having a metallic layer bonded to the external surface; and
coupling a printed layer to the metallic layer.
